(19) United States
(12) Patent Application Publication
(10) Pub. No.: US 2013/0183472 A1
(43) Pub. Date: Jul. 18, 2013

(54) LAYERED FILM FOR PROTECTING DISPLAY PANEL

(71) Applicants: Ho Rim Kang, Gyeonggi-do (KR); Moung Ki Jang, Gyeonggi-do (KR); Jeong Hyuk Jang, Gyeonggi-do (KR)

(72) Inventors: Ho Rim Kang, Gyeonggi-do (KR); Moung Ki Jang, Gyeonggi-do (KR); Jeong Hyuk Jang, Gyeonggi-do (KR)

(21) Appl. No.: 13/814,180

(22) PCT Filed: Mar. 15, 2012
(86) PCT No.: PCT/KR2012/001884

§ 371 Date: Feb. 4, 2013

(30) Foreign Application Priority Data
Jan. 16, 2012 (KR) 10-2012-0004702

(51) Int. Cl. B32B 27/08

(52) U.S. Cl. CPC B32B 27/08
USPC 428/41.8; 156/60

(57) ABSTRACT

The present invention relates to a multi-layered film for protecting display panel. Further, the multi-layered film of present invention comprises i) transparent polyurethane film having 20˜300 μm of width; ii) low elongation film having 1˜180% of elongation and 20˜300 μm of width; and iii) release sheet, wherein said transparent polyurethane film and said low elongation film are bonded by adhesive layer and said release sheet adheres to said film.

This is a 371 national phase application of PCT/KR2012/001884 filed on Mar. 15, 2012, claiming priority to Korean Patent Application No.10-2012-0004702 filed on Jan. 16, 2012, the contents of which are incorporated herein by reference.

### BACKGROUND OF THE INVENTION

1. Field of the Invention

The present invention relates to a layered film for protecting display panel. More specifically, this invention relates to a layered film for protecting LCD or LED display panel used for TV, tablet PC or smart phone. This film has dual functions for being securely attached in front of display panel as well as for protecting the display panel from scratching and cracking by relieving the external physical impact.

2. Description of Prior Art

Recently, lots of LCD or LED display have been used for display apparatus of TV, tablet PC or smart phone. The basic structure of LCD display panel comprises front and rear transparent electrodes and polarizing plate attached on the transparent electrodes, wherein liquid crystal material is injected and sealed between front and rear transparent electrodes. However, it is difficult for such a polarizing plate to have a sufficient resistance against external physical impact. Therefore, polarizing plate is easy to be scratched or cracked.

Therefore, a transparent protective film has been required for protecting LCD front display panel to minimize the scratching or cracking in the panel by relieving external physical impact.

Until now, the protective film used for LCD or LED panel has been usually manufactured using polyurethane resin showing excellent resistance to physical impact. However, it has a handicap for securely attaching to the front of display panel, because this film is easy to be elongated due to its high elongation property.

Therefore, the inventors have developed a multi-layered film for protecting display panel which is easily attached to the front of display panel along with being protected from external physical impact by layering both polyurethane film having enough elongation and resistance to physical impact and PET, PVC, PP or nylon film having low elongation.

### PROBLEM TO BE SOLVED

The problem to be solved of present application is to develop a multi-layered film for protecting LCD or LED display panel. In other words, this application is to develop a multi layered film for protecting display panel which is easily attached to the front of display panel along with being protected from external physical impact by layering both polyurethane film having enough elongation and resistance to physical impact and PET, PVC, PP or nylon film having low elongation.

### SUMMARY OF THE INVENTION

The object of present application is to provide a transparent multi-layered film for protecting display panel comprising i) transparent polyurethane film (10) having 20˜300 μm of thickness; ii) low elongation film (30) having 1˜180% of elongation rate with 20˜300 μm of thickness; iii) release sheet (40), wherein said film (10) and said film (30) are securely adhered by adhesive layer (20) and said sheet (40) is attached by sticky layer (21).

Further, said transparent polyurethane film (10) has been made by a flexible polyurethane film having 1.2˜1.3 g/cc of density, 450˜650 kg/cm² of tensile strength, 180˜600% of elongation rate.

Further, said low elongation film (30) has been made by the material selected from transparent PET, PVC, PP, nylon or transparent rigid polyurethane, and has 20˜150% of elongation rate and 10˜50 kg/cm² of tensile strength.

On the other hand, said transparent polyurethane film (10) has been made by a flexible polyurethane film having 250˜500% of elongation rate.

Further, said low elongation film (30) has been made by transparent polyethylene terephthalate(PET) having 40˜90% of elongation rate.

Further, the light transparency of said transparent multi-layered film is 85˜98%.

The other object of the present application is to provide a process for preparing a transparent multi-layered film comprising the steps of:

i) adhering a transparent polyurethane film (10) having 20˜300 μm of thickness to the low elongation film (30) having 1˜180% of elongation rate with 20˜300 μm of thickness using adhesive layer (20); and

ii) sticking said low elongation film (30) to the release sheet (40) using sticky layer (21).

### ADVANTAGEOUS EFFECT

The advantageous effect of present application is to provide a multi-layered film for protecting LCD or LED display panel. In other words, this application is to provide a multi layered film for protecting display panel which is easily attached to the front of display panel along with being protected from external physical impact by layering both polyurethane film having enough elongation and resistance to physical impact and PET, PVC, PP or nylon film having low elongation.

### BRIEF DESCRIPTION OF DRAWINGS

FIG. 1 shows an example of transparent multi-layered film for protecting LCD or LED display panel.

FIG. 2 shows the other example of transparent multi-layered film for protecting LCD or LED display panel.

FIG. 3 shows the improved example of transparent multi-layered film for protecting LCD or LED display panel.

Reference Numerals:

| | |
|---|---|
| 10: a transparent polyurethane film | 20: adhesive layer |

| | | |
|---|---|---|
| 21: sticky layer | 30: low elongation film | 40: release sheet |

### DETAILED DESCRIPTION OF THE INVENTION

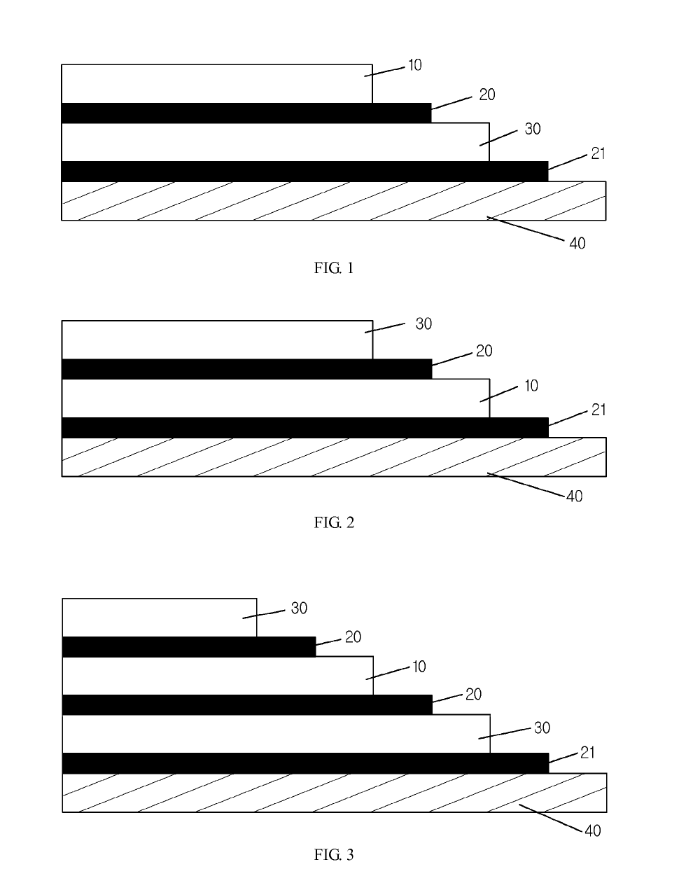

FIG. 1 shows an example of transparent multi-layered film for protecting LCD or LED display panel.

As shown in FIG. 1, the multi-layered film of present application consists of 5 layers. At the top, a polyurethane film (10) is located, a low elongation film (30) is adhered to said polyurethane film and a release sheet (40) is attached at the bottom. Said release sheet will be released at the time of attaching the said multi-layered film to the LCD or LED display panel.

Therefore, the multi-layered film of present application will be attached to LCD or LED display panel by sticky layer (21). Any commercialized polymer material can be used for sticky layer if the sticky property cannot be reduced after removing release sheet.

The physical properties of transparent polyurethane film (10) are 1.2˜1.3 g/cc of density, 450˜650 kg/cm² of tensile strength, 180˜600% of elongation rate. As a material of transparent polyurethane film, a flexible thermoplastic polyurethane is preferred. However, the material cannot be limited if polyurethane has enough elasticity to relieve the external physical impact. The preferred elongation rate of flexible polyurethane film is 250˜500%.

The physical properties of low elongation film (30) are 20˜150% of elongation rate and 10˜50 kg/cm² of tensile strength. As a material of low elongation film, transparent PET, PVC, PP, nylon or transparent rigid polyurethane can be used.

Preferably, transparent PET met with above physical property can be used as a material of low elongation film (30). More preferably, transparent polyethylene terephthalate(PET) having 40˜90% of elongation rate can be used.

Further, PET release sheet can be used as preferred release sheet (40).

Further, the light transparency of said transparent multi-layered film for protecting display panel is 85˜98%.

Between transparent polyurethane film (10) and low elongation film (30), adhesive layer (20) is present. As a material of adhesive layer, any adhesive which is able to securely adhere transparent polyurethane film and low elongation film can be used.

On the other hand, transparent polyurethane film and low elongation film can be adhered by adhesive coating material with heat treatment.

FIG. 2 shows the other example of transparent multi-layered film for protecting LCD or LED display panel.

As shown in FIG. 2, the multi-layered film of present application consists of 5 layers. At the top, a low elongation film (30) is located, a polyurethane film (10) is adhered to said low elongation film and a release sheet (40) is attached at the bottom. Said release sheet will be released at the time of attaching the said multi-layered film to the LCD or LED display panel.

Therefore, the multi-layered film of present application will be attached to LCD or LED display panel by sticky layer (21). Any commercialized polymer material can be used for sticky layer if the sticky property cannot be reduced after removing release sheet.

FIG. 3 shows the improved example of transparent multi-layered film for protecting LCD or LED display panel.

As shown in FIG. 3, a transparent multi-layered film for protecting display panel has following structure. A transparent polyurethane film (10) is located at the core and 2 low elongation films (30) are adhered to the top and bottom of transparent polyurethane film (10) through adhesive layers (20). At the bottom of low elongation films (30), release sheet (40) is attached through sticky layer (21).

Therefore, the multi-layered film of present application consists of 7 layers. A transparent polyurethane film (10) is located at the core and 2 low elongation films (30) are adhered to the top and bottom of transparent polyurethane film (10) through adhesive layers (20). At the bottom of low elongation films (30), release sheet (40) is attached through sticky layer (21). Said release sheet will be released at the time of attaching the said multi-layered film to the LCD or LED display panel.

### INDUSTRIAL APPLICABILITY

The industrial applicability of present application is to provide a multi-layered film for protecting LCD or LED display panel. In other words, this application is to provide a multi layered film for protecting display panel which is easily attached to the front of display panel along with being protected from external physical impact by layering both polyurethane film having enough elongation and resistance to physical impact and PET, PVC, PP or nylon film having low elongation.

1. A transparent multi-layered film for protecting display panel comprising i) transparent polyurethane film having 20˜300 μm of thickness; ii) low elongation film having 1˜180% of elongation rate with 20˜300 μm of thickness; iii) release sheet, wherein said film and said film are securely adhered by adhesive layer and said sheet is attached by sticky layer.

2. The transparent multi-layered film for protecting display panel according to claim 1, wherein said transparent polyurethane film has been made by a flexible polyurethane film having 1.2˜1.3 g/cc of density, 450˜650 kg/cm² of tensile strength, 180˜600% of elongation rate.

3. The transparent multi-layered film for protecting display panel according to claim 1, wherein said low elongation film has been made by the material selected from transparent PET, PVC, PP, nylon or transparent rigid polyurethane, and has 20˜150% of elongation rate and 10˜50 kg/cm² of tensile strength.

4. The transparent multi-layered film for protecting display panel according to claim 2, wherein said transparent polyurethane film has been made by a flexible polyurethane film having 250˜500% of elongation rate.

5. The transparent multi-layered film for protecting display panel according to claim 3, wherein said low elongation film has been made by transparent polyethylene terephthalate(PET) having 40˜90% of elongation rate.

6. The transparent multi-layered film for protecting display panel according to claim 1, wherein the light transparency of said transparent multi-layered film is 85˜98%.

7. A process for preparing a transparent multi-layered film comprising the steps of:
i) adhering a transparent polyurethane film having 20˜300 μm of thickness to the low elongation film having 1˜180% of elongation rate with 20˜300 μm of thickness using adhesive layer; and
ii) sticking said low elongation film to the release sheet using sticky layer.
